(19) United States
(12) Patent Application Publication
(10) Pub. No.: US 2019/0302353 A1
(43) Pub. Date: Oct. 3, 2019

(54) LIGHTING DEVICE AND DISPLAY DEVICE

(71) Applicant: SHARP KABUSHIKI KAISHA, Sakai City (JP)

(72) Inventor: OSAMU ITOH, Sakai City (JP)

(21) Appl. No.: 16/371,640

(22) Filed: Apr. 1, 2019

(30) Foreign Application Priority Data
Apr. 2, 2018 (JP) 2018-070723

(51) Int. Cl. F21V 8/00

(52) U.S. Cl. CPC G02B 6/0088

(57) ABSTRACT

A lighting device includes a light source, a light, guide plate including a light source-opposing part opposite the light source and a light exit surface, and a frame provided along an outer periphery of the light guide plate and configured to reflect at least, a part of light rays leaking through a peripheral part of the light guide plate toward a light guide plate side. The frame includes a frame main body part extending along the outer periphery of the light guide plate and protruding parts protruding toward the light guide plate from the frame main body part, and the protruding parts create a convergence space that includes a gap in a direction orthogonal to the light exit surface, and the gap is decreased as is closer to the frame main body part.

### CROSS REFERENCE TO RELATED APPLICATION

This application claims priority from Japanese Patent Application No. 2018-70723 filed on Apr. 2, 2018. The entire contents of the priority application are incorporated herein by reference.

### TECHNICAL FIELD

The technology described herein relates to a lighting device, and relates to a display device provided with the lighting device.

### BACKGROUND

As an example of a lighting device, one with which a display device is equipped is known, and in the following patent document 1, described is the lighting device which has a light source and a light guide plate and is configured to illuminate an member to be illuminated while having a light of the light source incident from the portion opposed to the light source among peripheral end faces of the light guide plate and having the light emitted from any one of a pair of plate surfaces. Then, the lighting device described in the following patent document 1 is characterized by a reflecting layer being formed in the inner-surface of a frame arranged so as to surround the light guide plate and being configured to reflect a light leaked from peripheral parts of the light guide plate, and enhancement of a light utilization efficiency has been achieved.

[Patent Document 1] WO 2014/065063

### SUMMARY

However, as for the lighting device described in the above-mentioned patent document 1, a light emitted from the vicinity of the outer periphery of the light guide plate increases, and a light has leaked from the vicinity of the frame to the member to be illuminated side without a light reflected by the reflecting layer returning to the light guide plate, and therefore, there is a problem that non-uniformity (luminance non-uniformity) arises in a light by which a member to be illuminated is illuminated.

The technology described herein was made in view of the above circumstances. An object is to suppress luminance non-uniformity while keeping light use efficiency.

A lighting device of the technology described herein includes a light source, a light guide plate having peripheral edge surface a part of which is a light source-opposing part opposite the light source and having a pair of plate surfaces one of which is a light exit surface, the light source-opposing part through which light from the light source enters, and the light exit surface through which the light exits, and a frame provided along an outer periphery of the light guide plate and configured to reflect at least a part of light rays leaking through a peripheral part of the light guide plate toward a light guide plate side. The frame includes a frame main body part extending along the outer periphery of the light guide plate and protruding parts protruding toward the light guide plate from the frame main body part, and the protruding parts create a convergence space that includes a gap in a direction orthogonal to the light exit surface, and the gap is decreased as is closer to the frame main body part.

For example, when a frame reflects a light in a wall surface parallel to the peripheral end face of the light guide plate, there is a possibility that the light having a component in a direction directed to a member to be illuminated while inclined greatly with respect to the level surface may be emitted toward a member to be illuminated when reflected on the wall surface of the frame. On the other hand, according to the lighting device configured as mentioned above, an amount of the light emitted toward a member to be illuminated by reflection on the frame can be suppressed since a light inclined greatly with respect to a horizontal direction can be made to be attenuated by being reflected multiple-times in the convergence space. In addition, since the light becoming close to a horizontal direction by being reflected by two or more or protruding parts is returned to the light guide plate, a utilization efficiency of a light can be enhanced as compared with the case where the frame does not reflect the light.

According to the technology described herein, luminance non-uniformity can be suppressed while keeping light use efficiency.

### BRIEF DESCRIPTION OF THE DRAWINGS

FIG. 1 is an exploded perspective view of a display device of a first embodiment.

FIG. 2 is a side face sectional view of the display device of the first embodiment.

FIG. 3 is a level surface sectional view of the display device of the first embodiment.

FIG. 4 is a side face sectional view expanding and illustrating a principal part of the display device of the first embodiment.

FIG. 5 is a level surface sectional view of a display device which is a modification example of the first embodiment.

FIG. 6 is a front view of a frame illustrated in FIG. 5.

FIG. 7 is a front view of a frame of a lighting device with which provided is a display device of a second embodiment.

FIG. 8 is a front view of a frame of a lighting device with which provided is a display device of a 3rd embodiment.

### DETAILED DESCRIPTION

Hereinafter, as configurations for carrying out the technology described herein, some embodiments of the technology described herein will be described in detail with reference to a drawing. Incidentally, the technology described herein is not limited to the following embodiment, and can be carried out in various modes where various changes and improvements are carried out based on knowledges of persons skilled in the art.

### First Embodiment

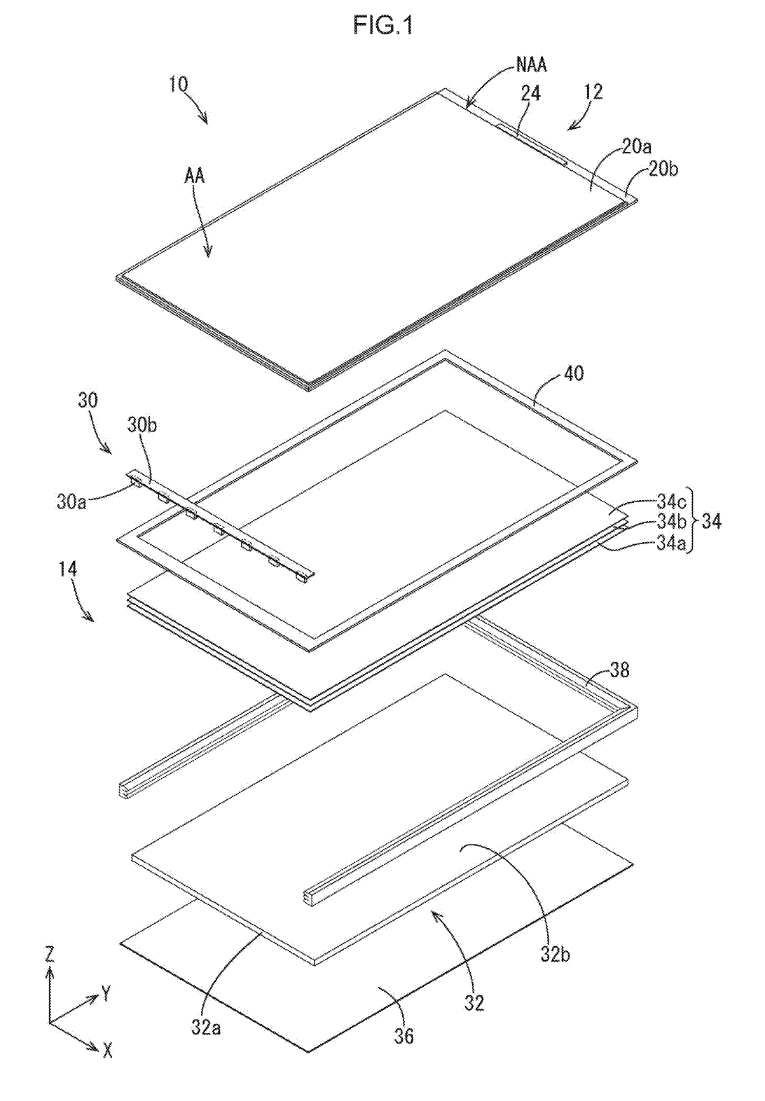

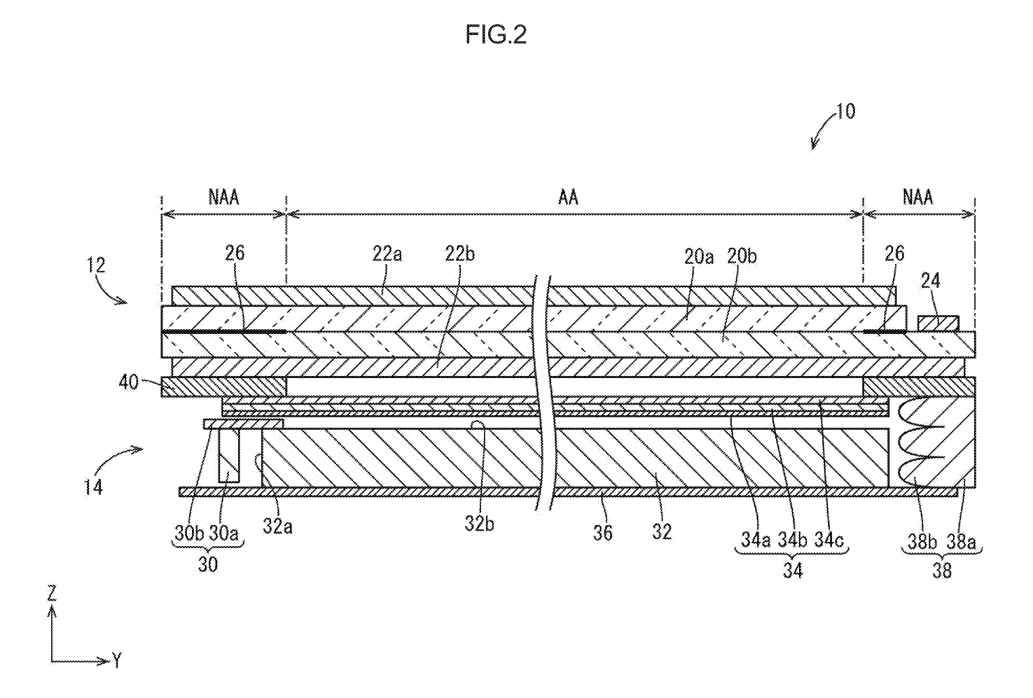

A Liquid crystal display device 10 which is a display device of a first embodiment of the technology described herein will be illustrated in an exploded perspective view of FIG. 1 and a sectional view of FIG. 2. As illustrated in FIG. 1, the liquid crystal display device 10 makes a longwise rectangular shape as the whole. The Liquid crystal display device 10 includes a liquid crystal panel 12 as a display panel capable of displaying an image, and a back light device 14 which is the lighting device of the technology described herein irradiating the liquid crystal panel 12 with light for image displaying. Although the liquid crystal display device 10 is used for personal digital assistants such as a smart phone, for example, it is not limited to this. Note that in a part of each drawing, X-axis, Y-axis and Z-axis are illustrated, and the direction of each axis is drawn so as to be a common direction in each drawing. A short side direction in the liquid crystal display device 10 coincides with the X axial direction of each drawing, and a long side direction coincides with the Y axial direction of each drawing. In addition, the direction orthogonal to the XY planes coincides with the Z axial direction, and may be referred to as a vertical direction on the basis of FIG. 2.

The liquid crystal panel 12 has a pair of substrates 20a and 20b which are almost transparent and have an excellent translucency. Among a pair of substrates 20a and 20b, the upper part (front side) is assumed to be a CF substrate 20a, and the under-side (back side) is assumed to be an array-substrate 20b. On the external surface side of a pair of substrates 20a and 20b, a pair of polarizing plates 22a and 22b are pasted. In addition, while a pair of substrates 20a and 20b are stuck together in a state with a prescribed gap maintained, the liquid crystal panel 12 is sandwiched between the pair of substrates 20a and 20b, and has a liquid crystal layer including a liquid crystal element which is a material with an optical property changed in accordance with electric field application, and a seal part which surrounds the liquid crystal layer and seals the liquid crystal layer (illustration omitted in both cases). One end part of the long side direction in the array substrate 20b is protruded outside the CF substrate 20a, and on the protruded portion, a LCD controller 24 for controlling the liquid crystal panel 12 is mounted, for example.

Although internal structures of the liquid crystal panel 12 will be described briefly, illustration of the various structures related to the internal structure will be omitted with a few exceptions. On an inner-surface side of the array substrate 20b, TFTs (Thin Film Transistor) which are switching elements and picture element electrodes are arranged in order in large numbers in a matrix state (matrix form). On an inner-surface side of the array substrate 20b, a gate line and a source line which make a lattice shape are arranged so as to surround the TFT and the picture element electrode. Through the gate line and the source line, a signal related to a picture is each transmitted. On the other hand, on an inner-surface side of the CF substrate 20a, many color filters are provided at the positions corresponding to each picture element electrode. Color filters are assumed to be arranged with 3 colors of R, G and B located by turns. On the inner-surface side of the CF substrate 20a, a shade part (black matrix) 26 is provided for preventing colors between adjacent color filters from being mixed, etc. Although a detailed illustration is omitted, the shade part 26 is formed in a lattice shape so as to separate between adjacent color filters in a display area AA of a center portion in the liquid crystal panel 12. On the other hand, the shade part 26 is formed in a solid state in a non-display area NAA of the peripheral part in the liquid crystal panel 12.

The back light device 14 is arranged in the back side of the liquid crystal panel 12, and is configured to include a light source 30, a light guide plate 32 having a square plate shape which guides light from the light source 30, an optical sheet 34 arranged on the front side of the light guide plate 32, a light reflection sheet 36 arranged on the back side of the light guide plate 32, and a frame 38 formed in a shape so as to surround the light guide plate 32 and the optical sheet 34. The back light device 14 is assumed to be an edge light type of a one side incident type where the light of the light source 30 is incident only from one side to the light guide plate 32. The light source 30 is arranged at one end of a pair of ends in the long side direction of the back light device 14.

The light source 30 is configured to include two or more of LED 30a (Light Emitting Diode), and a LED substrate 30b having these two or more of LED 30a mounted thereon. Each LED 30a is made by scaling a LED chip with a sealing agent. Each LED 30a has the LED chip assumed to emit a blue light monochromatically, for example, and emits a white light as a whole by fluorescent materials (a yellow fluorescent material, a green fluorescent material, a red fluorescent material, etc.) being compounded dispersedly with the sealing agent. Note that the configuration of the LED 30a is not limited to this, but can be changed suitably. The LED substrate 30b makes a film shape (sheet shaped) which is made from an insulating material and has flexibility, and on the LED substrate 30b, two or more of the LED 30a are mounted leaving intervals in a line. Although two or more of the LED 30a are arranged at equal intervals, for example, it is not limited to this.

The light guide plate 32 is assumed to be an almost transparent synthetic resin material (acrylic resins and polycarbonate, etc., such as PMMA, for example), and a refractive index is made to be higher enough than air. As illustrated in FIG. 1, the light guide plate 32 makes longwise square plate shape like the liquid crystal panel 12. As illustrated in FIG. 2, one face among the peripheral end faces of four sides in the light guide plate 32 is assumed to be a light-source opposing face (light-source opposing part) 32a arranged oppositely to the light source 30. The light-source opposing face 32a has extended linearly along an arrangement direction of two or more of the LED 30a (refer to FIG. 1). Then, the light emitted from the light source 30 is introduced into the inside of the light guide plate 32 from the light-source opposing face 32a. On the other hand, the plate surface facing the front side (the liquid crystal panel 12 side) among a pair of plate surfaces of the light guide plate 32 is assumed to be a light exit surface 32b, and the light introduced into the light guide plate 32 is emitted towards the optical sheet 34 side from the light exit surface 32b after being propagated in the inside.

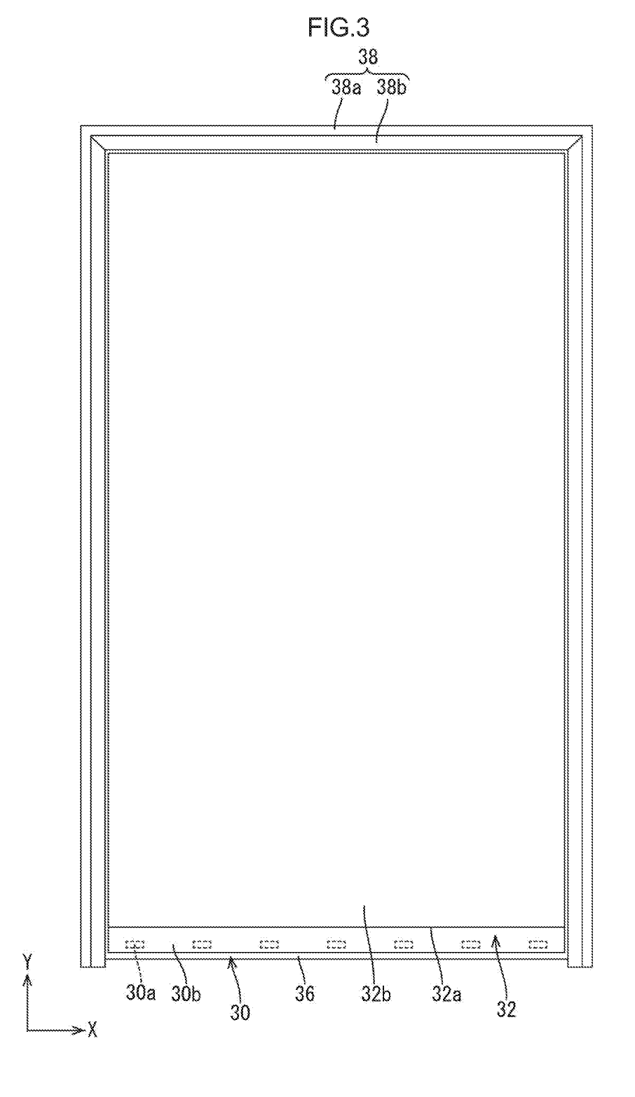

The optical sheet 34 is constituted of a micro lens sheet 34a which gives light an isotropic light-condensing effect, a prism sheet 34b which gives light an anisotropic light-condensing effect, and a reflection type polarizing sheet 34c which polarize-reflects light. In addition, a micro lens sheet 34a, a prism sheet 34b, and a reflection type polarizing sheet 34c are laminated in order from the back side. Incidentally, the type and number of each of sheets which constitute the optical sheet 34 can be changed suitably. The light reflection sheet 36 is excellent in light reflection characteristics, and has a function to reflect toward the front side the light leaked from a plate surface opposite to the light exit surface 32b in the light guide plate 32. The frame 38 is made from a synthetic resin whose surface exhibits white (made from polycarbonate, for example), and is assumed to one which is U-shaped as illustrated in FIG. 1 and FIG. 3, and is arranged so as to surround a portion excluding the light-source opposing face 32a of the light guide plate 32. The frame 38 is fixed to the liquid crystal panel 12 via a fixing tape 40 which has a light blocking effect. Then, the liquid crystal panel 12 is arranged in a form which is overlapped with the light exit surface 32b of the light guide plate 32, and is configured to be able to display a picture using the light emitted from the light exit surface 32b.

The frame 38 is assumed to be made from a synthetic resin of which the surface exhibits white as mentioned above, and has a function to reflect the light leaked from the vicinity of the outer periphery of the light guide plate 32. The back light device 14 which the lighting device of the technology described herein is one which has features in a shape of the frame 38, and will be described in detail in the following.

As for the back light device in the past, an inner wall of the frame was made of a mere plane (face almost parallel to the side face of the light guide plate), and therefore, when the light leaked from the vicinity of the outer periphery of the light guide plate 32 is all reflected by the frame, the light emitted to the display area AA of the liquid crystal panel 12 from the vicinity of the outer periphery of the light guide plate increases or the like, and the light has leaked from the vicinity of the frame to the display area AA of the liquid crystal panel 12 without the light reflected by the frame returning to the light guide plate, or the like. Because of that, there is a problem that the vicinity of the outer periphery of liquid crystal panel 12 has become bright.

As illustrated in FIG. 1, the frame 38 of the back light device 14 according to the present embodiment has a frame main body part 38a which is erected outside the light guide plate 32 and surrounds three sides excluding the light-source opposing face 32a in the peripheral end face, and protrusions 38b (three in the present, embodiment) that extend along the peripheral end face of the light guide plate 32 and protrude toward the light guide plate 32 in the inner wall of the frame main body part 38a. The protrusions 38b are arranged side by side in a vertical direction (Z-direction, direction orthogonal to the light exit surface 32b), and are each assumed to have a mound-shaped cross section, or a cross section of a curved surface shape swelling outward in detail. In addition, a convergence space 38c where the closer is a distance to the frame main body part 38a, the narrower becomes a gap in a vertical direction is formed between two of the protrusions 38b. In other words, in the present embodiment, it can be considered that two or more of protruding parts are arranged in all parts excluding the light-source opposing face 32a among peripheral end faces by the protrusions 38b being arranged along the inner wall of the frame main body part 38a.

Incidentally, it can be considered that as for the configuration of the frame 38 in the present embodiment, two or more of grooves extending along the peripheral face of the light guide plate 32 are formed in the surface of the light guide plate 32 side of the frame 38, and these two or more of grooves have been made to be ones which function as the convergence space 38c. In addition, although as for the protrusions 38b, the cross-sectional shape has been assumed to be the mound shape of the curved surface shape swelling outward in the present embodiment, the cross-sectional shape may be a mound shape of a curved surface shape recessed inwardly, and may be a mound shape of a linear shape.

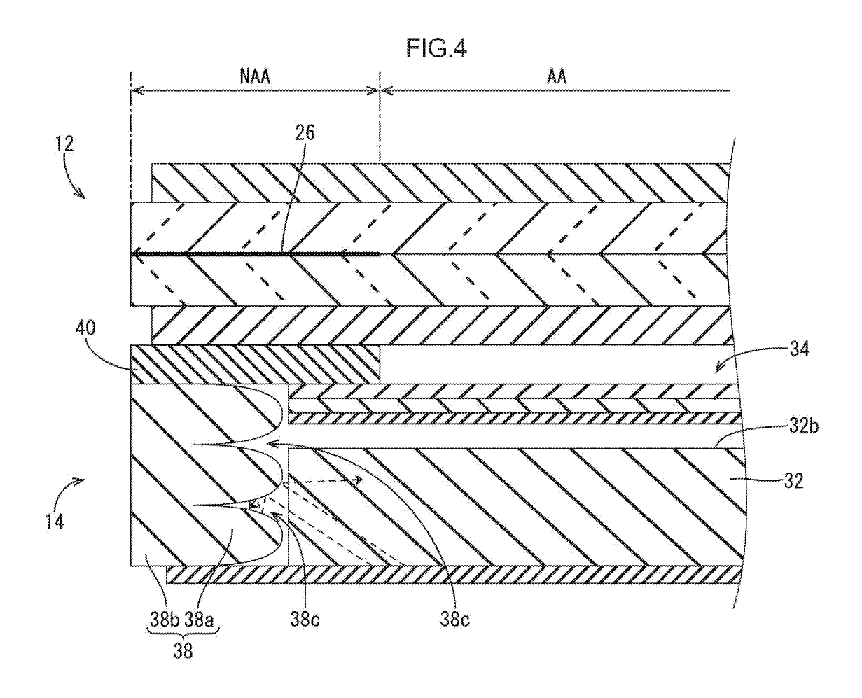

For example, in a case where the light which leaks outside from the peripheral face of the light guide plate 32 becomes one having a component which inclines greatly (close to a critical angle) with respect to a level surface and turns upwards (front wide), the light may be reflected by the inner wall of the frame and have been emitted from the display area AA of the liquid crystal panel 12 in the back light device in the past mentioned above. In contrast to this, as for the present back light device 14, a part of the light as described above will be reflected in the portion which is close to the tip and faces downward in the protrusion 38b, and be returned to the light guide plate 32 as illustrated in FIG. 4, for example because the frame 38 has two or more of the protrusions 38b. In addition, other part of light enters in the convergence space 38c and is made to be attenuated by being reflected multiple times between two protrusions 38b forming the convergence space 38c. As the result, according to the liquid crystal display device 10 of the present embodiment, a part of the light which is leaked from the peripheral lace of the light guide plate 32 and is close to a critical angle can be returned to the light guide plate 32 and be attenuated in the convergence space 38c, and as the result, an amount of the light which leaks into the display area AA can be suppressed by the reflection in the frame 38 while keeping an utilization efficiency of a light.

### MODIFICATION EXAMPLE

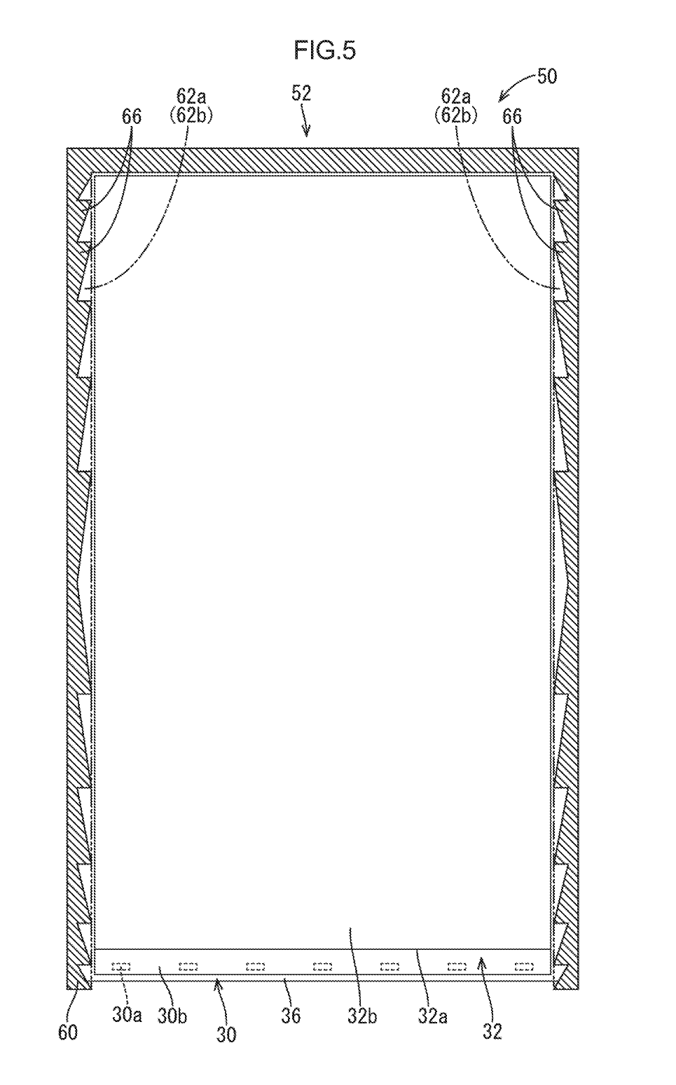

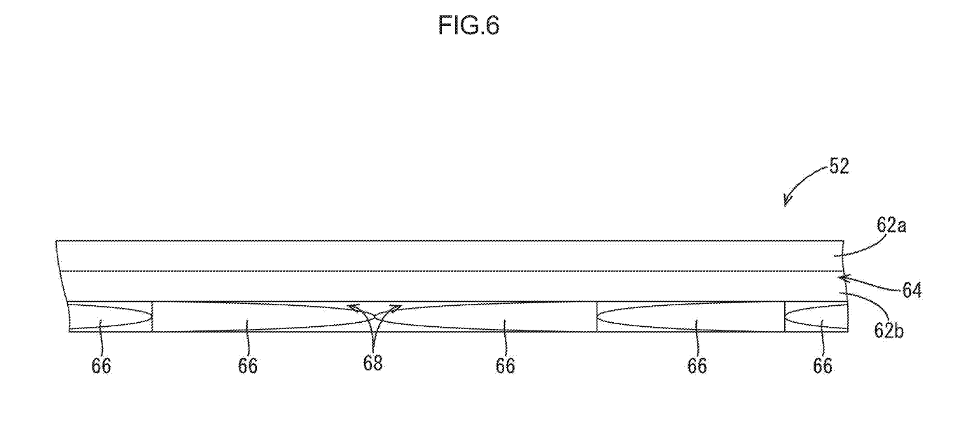

A liquid crystal display device 50 of a modification example of the above-mentioned embodiment will be illustrated in FIG. 5 and FIG. 6. From the liquid crystal display device 10 of the first embodiment mentioned above, only the shape of the frame which constitutes the back light device differs. As for a frame 52 according to the present modification example, two protrusions 62a and 62b which have the same shape as the protrusion 36b of the frame 38 of the first embodiment mentioned above are provided with respect to a frame main body part 60 as illustrated in the front view of the frame 52 of FIG. 6, and a convergence space 64 is formed between them.

In addition, in a downward side (rear face side) of the two protrusions 62a and 62b as illustrated in FIG. 6, two or more of protruding parts 66 are arranged side by side in a direction in which two protrusions 62a and 62b extend. As for each of these two or more of the protruding parts 66, a cross-sectional shape in a vertical plane is each assumed to be the mound-shaped cross section of the curved surface shape to swelling outward in the same way as the two protrusions 62a and 62b. However, as illustrated in FIG. 5, as for each of the two or more of protruding parts 66, the cross-sectional shape in a level surface is inclined with respect to the direction in which the frame main body part 60 extend, and is made to be a shape facing a center side of the light guide plate 32. Note that al so between these two or more of the protruding parts 66 and the protrusion 62b, a convergence space 68 is formed.

As for the liquid crystal display device 50 of the present modification example configured as mentioned above, a part of the light which is leaked from the peripheral face of the light guide plate 32 and is close to a critical angle can be returned to the light guide plate 32 and be attenuated in the convergence spaces 64 and 68, by the two protrusions 62a and 62b and two or more of the protruding parts 66 and the convergence spaces 64 and 68 formed between them in the same way as the liquid crystal display device 10 of the first embodiment mentioned above, and as the result, an amount of the light which leaks into the display area AA can be suppressed by the reflection in the frame 52 while keeping the utilization efficiency of the light. In addition, as for the liquid crystal display device 50 of the present modification example, two or more of the protruding parts 66 is assumed to have a face facing the center of the light guide plate 32, and as the result, the light reflected by these two or more of the protruding parts 66 can be collected in the center side of the light guide plate 32 in a plane view, and the utilization efficiency of the light can be enhanced.

### Second Embodiment

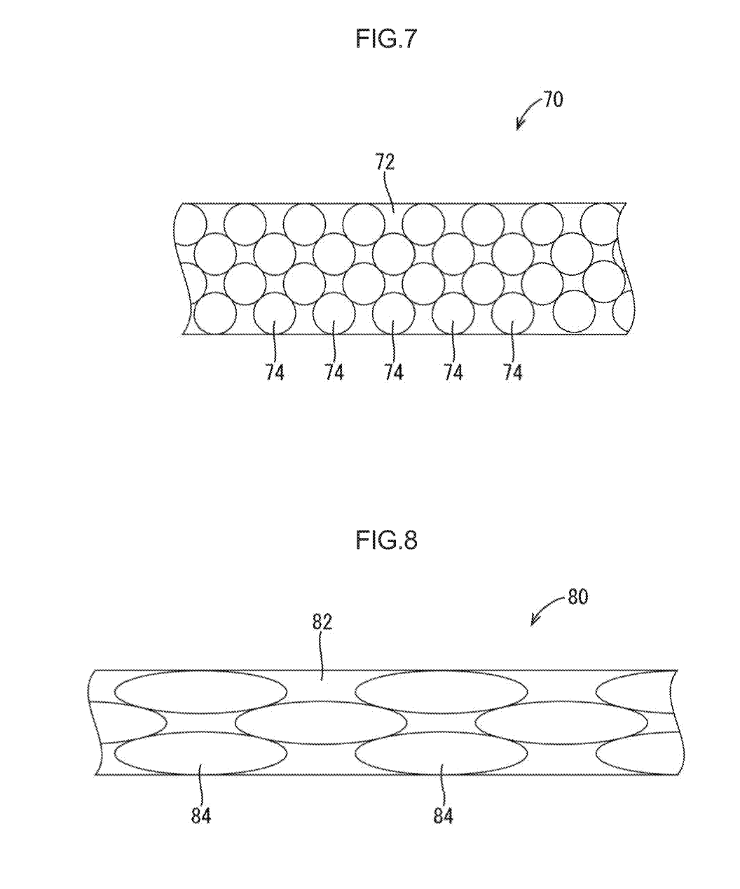

In the present embodiment, a frame 70 has two or more of hemisphere-shaped protruding parts 74 arranged in a frame main body part 72 as illustrated in a front view of FIG. 7. Incidentally, in the present embodiment, two or more of the hemisphere-shaped protruding parts 74 are arranged in a staggered manner, and however, may be arranged in a lattice shape and arranged at random. Then, in the liquid crystal display device of the present embodiment, a space between adjacent ones among two or more of the protruding parts 74 functions as the convergence space.

As the result, also in the present embodiment, a part of the light which is leaked from the peripheral face of the light guide plate 32 and is close to a critical angle can be returned to the light guide plate 32 and be attenuated in the convergence space, and as the result, an amount of the light which leaks into the display area AA can be suppressed by the reflection in the frame 70 while keeping the utilization efficiency of the light.

In addition, as illustrated in FIG. 8, a frame 80 with which a back light device is provided can also be made to be one having two or more of ellipse-shaped protruding parts 84 arranged in a frame main body part 82. In this case, a space between overlapped portions in the vertical direction of two or more of protruding parts 84 functions as the convergence space.

1. A lighting device comprising:
a light source;
a light guide plate having peripheral edge surface a part of which is a light source-opposing part opposite the light source and having a pair of plate surfaces one of which is a light exit surface, the light source-opposing part through which light from the light source enters, and the light exit surface through which the light exits; and
a frame provided along an outer periphery of the light guide plate and configured to reflect at least a part of light rays leaking through a peripheral part of the light guide plate toward a light guide plate side,
the frame including a frame main body part extending along the outer periphery of the light guide plate and protruding parts protruding toward the light guide plate from the frame main body part, and the protruding parts creating a convergence space that includes a gap in a direction orthogonal to the light exit surface, and the gap being decreased as is closer to the frame main body part.

2. The lighting device according to claim 1, wherein some of the protruding parts have a cross-sectional shape of a mound shape taken in a direction orthogonal to an extending direction of the frame main body part, and the convergence space is between two of the protruding parts arranged side by side in a direction orthogonal to the light exit surface.

3. The lighting device according to claim 2, wherein some of the protruding parts have a cross-sectional shape of a mound shape of a curved surface shape taken in a direction orthogonal to an extending direction of the frame main body part.

4. The lighting device according to claim 1, wherein
the protruding parts include protrusions extending along the peripheral end surface of the light guide plate and having a mound-shaped cross section and the protrusions are arranged side by side in a direction orthogonal to the light exit surface, and
the convergence space is a space between the protrusions.

5. The lighting device according to claim 4, wherein the protrusions have a cross-sectional shape of a mound shape of a curved surface shape.

6. The lighting device according to claim 1, wherein some of the protrusions face a center of the light guide plate.

7. The lighting device according to claim 1, wherein the protrusions are arranged in an entire area of the peripheral end faces of the light guide plate excluding the light source-opposing part.

8. A display device comprising:
the lighting device according to claim 1; and
a display panel configured to display an image using a light from the lighting device.

9. The display device according to claim 8, wherein the display panel is a liquid crystal panel including a pair of substrates and liquid crystals enclosed between the substrates.
